(19) United States
(12) Patent Application Publication
(10) Pub. No.: US 2005/0002436 A1
(43) Pub. Date: Jan. 6, 2005

(54) Method for measuring thermophysical property of thin film and apparatus therefor

(76) Inventors: Naoyuki Taketoshi, Ibaraki (JP); Tetsuya Baba, Ibaraki (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/839,214

(22) Filed: May 6, 2004

(30) Foreign Application Priority Data
May 7, 2003 (JP) 2003-128738

(51) Int. Cl. G01N 25/20

(52) U.S. Cl. 374/43

(57) ABSTRACT

It is an object of the present invention to to realize heat capacity measurement per unit area of a thin film with a thickness of 1 micrometer or less which is formed a substrate. According to the present invention, a ratio of a heat capacity per unit area of the thin film formed on a substrate and a thermal effusivity of the substrate is measured and regarding a thermal effusivity of the substrate as a known value, a heat capacity per unit area of the thin film is measured.

### TECHNICAL FIELD OF THE INVENTION

The present invention relates to a method for measuring thermophysical property of thin film, and specifically to a method for measuring the heat capacity, specific heat capacity, a thermal diffusivity, or thermal conductivity of a thin film.

### DESCRIPTION OF RELATED ART

A DSC is known as a practical and widespread heat capacity measuring device. The heat capacity of a thin film is measured from a supplied heat flow and a temperature rise.

In a differential laser flash method, unknown heat capacity of a disc-shaped sample is measured from the ratio of temperature changes obtained by simultaneously applying pulse heat to the disc-shaped sample whose heat capacity is unknown and a disc-shaped reference sample whose heat capacity is known.

In either case, bulk material is used, and the diameter and the thickness of the sample are usually about 5 mm and about 1 mm, respectively.

However, since the heat capacity of the thin film is 10⁻² to 10⁻⁵ of the heat capacity of a substrate in case that the thin film has a thickness on the order of 100's of nanometers, and is formed on the substrate with a thickness of about 1 mm, the heat capacity of the sample can hardly be measured by the conventional method.

According to a picosecond thermo-reflectance method whose theory is the same as that of the laser flash method, although it is possible to observe a signal(s) depending on the heat capacity of a thin film, since it is necessary to accurately obtain a reflectance of the thin film, or the temperature coefficient of the reflectance, the absorption coefficient, and the intensity distribution of a light exposure area in order to calculate the absolute value of the heat capacity, and it is necessary to individually and separately measure them from various thin films, the method for measuring the heat capacity of the thin film is unrealistic in practice.

The picosecond thermo-reflectance method is a method of measuring the thermal diffusivity of a thin film with a thickness of 1 micrometer or less.

FIG. 1 shows a block diagram of a general picosecond thermo-reflectance signal measuring apparatus that the inventors have already proposed.

Pulse light with the pulse widths of approximately 2 picoseconds from a light source 1 is repeatedly emitted (oscillated) at the frequency fᵣₑₚ (approximately 76 Mhz), and the emitted light is divided into sample heating light and temperature measuring light by a beam splitter 2.

When the sample heating light passes through an acousto-optic modulator 3, intensity modulation at a frequency f_{mod} (approximately 1 MHz) is carried out. A signal(s) for modulation is generated by a frequency generator 4. The heating light to which the intensity modulation has been carried out is irradiated onto an interface 7 of the thin film sample 6 in which thin films are laminated on a substrate, and the temperature measuring pulse light is irradiated onto a thin film surface 8 of a heating light exposure area.

As shown in FIG. 2, the temperature measuring pulse light which is repeatedly oscillated at a constant frequency fᵣₑₚ reaches the sample surface with delay time tₚₚ after the heating pulse reaches the sample surface. The intensity change of the reflected temperature measuring pulse light is proportional to the temperature at time when the tₚₚ second passes from the pulse heating.

Since the intensity of the heating light is modulated at the frequency f_{mod}, the intensity of the reflected temperature measuring light is also modulated at the frequency f_{mod}.

An intensity change of the temperature measuring light which is reflected on the sample is converted into an electric signal(s) by a detector 9 shown in FIG. 1.

Since a change of the reflectance (thermo-reflectance) proportional to the temperature change is as small as 10⁻⁴ to 10⁻⁵, compared to a 1K temperature rise, the component which is synchronized with modulation frequency f_{mod} among the detected signals is detected by a lock-in amplifier 5.

Since the reflected light intensity change to the pulse heating obtained by the picosecond thermo-reflectance method is proportional to the temperature rise, the thermal diffusivity of a thin film can be essentially calculated with the same principle as that of the laser flash method which is a thermal diffusivity measuring method of a bulk material.

The prior art related to the picosecond thermo-reflectance method is disclosed in Japanese Laid Open Patent Nos. 2000-121586, 2001-116711, 2001-83113, 2002-122559 etc., and the minute signal measuring method is disclosed in Japanese Laid Open Patent No. 2003-139585.

When the temperature of the thin film which is risen by a previous pulse heating light does not return to an initial temperature level by the time the following heating pulse light reaches the thin film, heat is accumulated in the inside of the thin film (refer to FIG. 3). For this reason, a signal with the modulation frequency f_{mod} is spontaneously generated as shown in FIG. 4.

At this time, the signal component which is synchronized with the modulation frequency f_{mod} is represented by addition of the signal proportional to the temperature rise by 1 pulse heating and the signal with the modulation frequency f_{mod} generated spontaneously.

Since the change to the delay time tₚₚ of the phase component which is synchronized with the modulation frequency f_{mod} is represented as a ratio of the temperature rise by the pulse heating to the signal amplitude generated spontaneously, it is not influenced by fluctuation of heating light intensity like a drift in the minute signal detection method using a phase component(s), compared with the amplitude component used conventionally. By combining this minute signal measuring method and picosecond thermo-reflectance method, measurement of a quantitative thermal diffusivity of the thin film with a thickness on the order of 100's of nanometers has been attainable.

### SUMMARY OF THE INVENTION

In order to figure out thermal energy movement in advanced multilayer films such as laminated composite material and thermal design of large-capacity storage medium such as a semiconductor device, an optical disc, a hard disk, and a magnetic optical disk, it is necessary to know not only the thermal diffusivity of each layer and the value of interface thermal resistance between layers but also the specific heat capacity of the thin film.

Conventionally, in the thermal design, although the specific heat capacity of the thin film is calculated from the specific heat capacity and the density of the bulk material, the specific heat capacity of the thin film differs or is not obvious from that of the bulk material, and there is a possibility that the specific heat capacity and density of the thin film differ depending on the condition of the thin film formation, it is necessary to actually measure the heat capacity of the thin film to be used.

However, in the case of a thin film with a thickness of approximately 100 nanometers formed on a substrate with a thickness of approximately 1 mm, in the conventional method, the heat capacity of the thin film can hardly be measured since the heat capacity of the thin film is approximately 10⁻² to 10⁻⁵ of the heat capacity of the substrate.

Therefore, it is an object of the present invention to realize heat capacity measurement per unit area of a thin film with a thickness of 1 micrometer or less which is formed a substrate.

The objects of the present invention is accomplished by a method or apparatus for measuring thermophysical property of a thin film formed on a substrate comprising the following steps of measuring a ratio of a heat capacity per unit area of the thin film and a thermal effusivity of the substrate, measuring a heat capacity per unit area of the thin film regarding the thermal effusivity as a known value.

The method or apparatus may further include a step or a device of heating a surface of the thin film by pulse light with a frequency f_{mod}, and a step or device of calculating a ratio of a heat capacity per unit area of the thin film and the thermal effusivity of the substrate, based on a phase component in temperature change of the surface of the thin film.

In the method or apparatus may further include a step or device of pulse-heating a surface of the thin film by pulse light with a repetition frequency fᵣₑₚ which is a frequency generated by carrying out intensity modulation to a frequency f_{mod}, and a step or device of calculating a ratio of a heat capacity per unit area of the thin film and a thermal effusivity of the substrate, based on a ratio of a temperature response of the frequency f_{mod} and a temperature rise generated before the thin film is heated by a following pulse.

The ratio of a temperature response of the frequency f_{mod} and a temperature rise generated before the thin film is heated by a following pulse may be measured from a phase change of a surface temperature, which is synthesized with the frequency f_{mod}.

Light may be used as a heating source.

Further, the heat capacity per unit volume may be measured by regarding a thickness of the thin film as a known value.

Furthermore, a specific heat capacity may be measured by regarding a density of the thin film.

### DESCRIPTION OF THE DRAWINGS

FIG. 1 is a block diagram of a measuring apparatus used in the present invention;

FIG. 2 is a diagram showing the principle of signal detection according to a picosecond thermo-reflectance method;

FIG. 3 ia a diagram qualitatively showing the temperature change on the surface of a sample by the heating pulse and the heating pulse light which is oscillated at a repeated frequency frp and whose intensity is modulated at the frequency f_{mod};

FIG. 4 is a schematic diagram for calculating method;

FIG. 5 shows a graph of measurement results of molybdenm thin films with 150 nm and 200 nm thicknes;

FIG. 6 is a cross sectional view showing an example of thin film sample.

### DETAILED DESCRIPTION OF THE INVENTION

The present invention will become more apparent from the following detailed description of the embodiments and examples of the present invention.

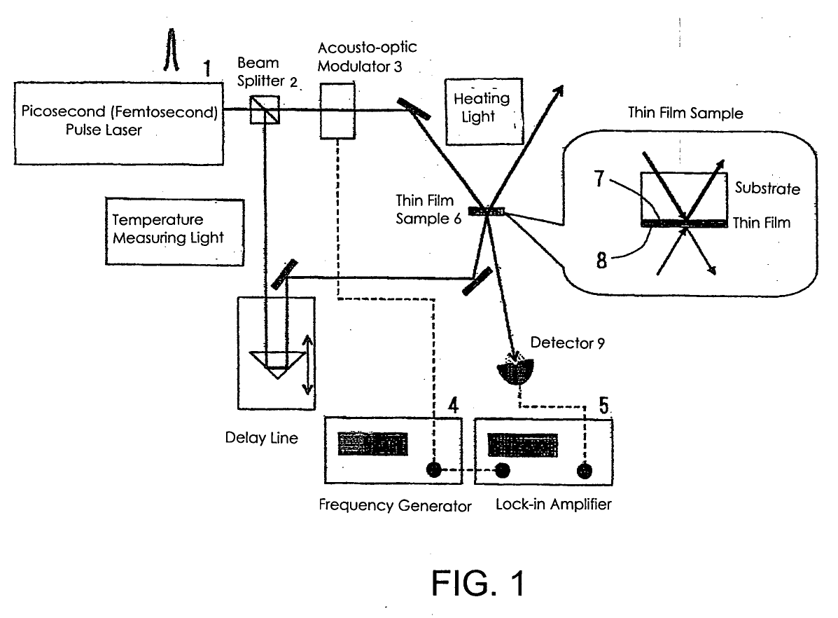

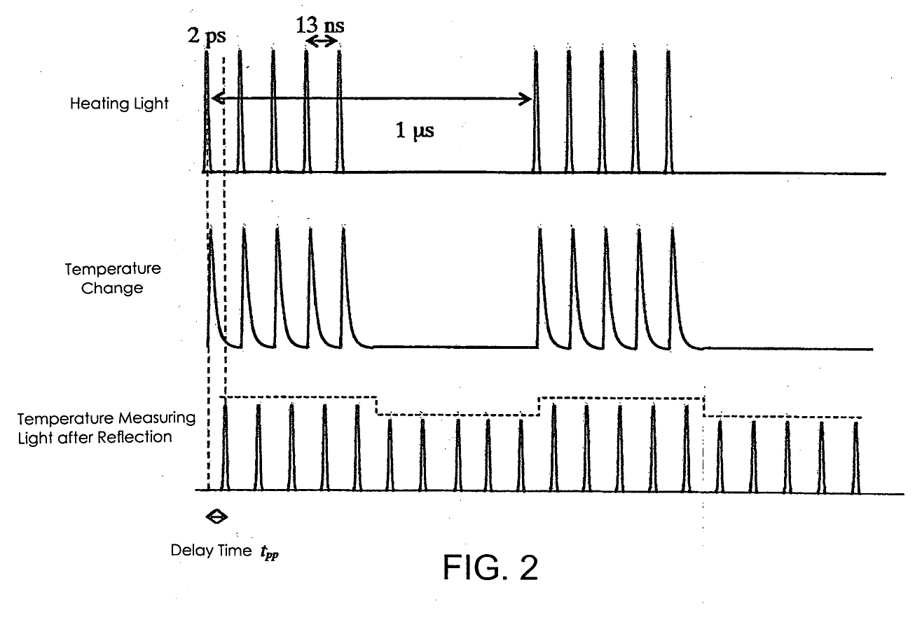

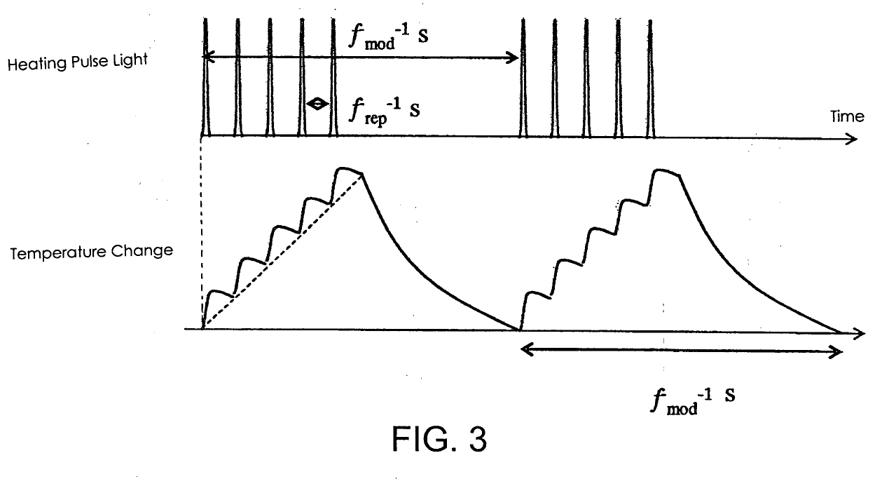

FIG. 1 shows the block diagram of an apparatus used in the present invention. In the embodiment, the picosecond thermo-reflectance signal measuring apparatus proposed by this inventors, as mentioned above is used.

In the apparatus shown in the figure, a Ti-sapphire laser which emits pulse light with the pulse width 2 picoseconds and oscillates at a frequency fᵣₑₚ (76 MHz) is used as a light source 1, and the light emitted from the laser is divided into a heating pulse light and a temperature measuring pulse light by the beam splitter 2.

When the repeatedly oscillating (emitting) heating pulse light passes through an acousto-optical modulator 3, the intensity of the light is modulated at the frequency of 1 MHz.

The 1 MHz frequency signal for intensity modulation is supplied by the frequency generator 4.

The signal for intensity modulation is used as a reference signal which is inputted to the lock-in amplifier 5.

In this embodiment, although the acousto-optical modulator 3 is used for modulation, for example, a mechanical chopper or an electrooptical crystal element may be used for it.

Although the modulation frequency f_{mod} is 1 MHz in this embodiment, it is required to be a frequency lower than the repetition frequency of the pulse, for example, from 500 kHz to 10 MHz is suitable as the modulation frequency f_{mod} when the repetition frequency fᵣₑₚ of the pulse light is 76 MHz.

The modulated heating light is condensed on the interface 7 of the thin film and the substrate of the thin film sample 6.

On the other hand, the temperature measuring light is condensed on the thin film surface 8 on the opposite side of the heated area.

The temperature measuring light reflected on the surface of the thin film sample 6 is detected by the detector 9 which can be made up by a silicon photodiode(s).

The detected signal is sent to a signal input terminal of the lock-in amplifier 5.

Since the heating light has a component which makes the temperature on the surface of the sample change due to the intensity modulation of heating light for 1 microseconds, the temperature measuring light reflected by the sample also includes 1 MHz frequency-component a little.

The alternate current component of the temperature measuring light which is synchronized with the 1 MHz intensity modulation frequency is detected by the lock-in amplifier.

Although the picosecond Ti-sapphire laser whose frequency fᵣₑₚ is 76 MHz is used for heating, any pulse laser which oscillates (or emits light) at a constant interval may be used as long as a frequency for the intensity modulation which is applied to the heating light is lower than the oscillation interval (frequency).

For example, when a pulse YAG laser emitting pulse light whose oscillating frequency fᵣₑₚ is 10 kHz is used as a light source, the intensity modulation frequency f_{mod} may be 500 Hz.

The detector 9 does not need to be a silicon photodiode, and any element or device may be used as long as it can generate an electric signal proportional to the intensity of the light which is incident to the element of the detector. For example, photomultipliers and the like may be used.

Time change of the reflectance change (thermo-reflectance) proportional to a temperature change is recorded while delay of the temperature measuring pulse light arriving time from the heating pulse light arriving time is changed by changing the position of a turning-over mirror.

In this embodiment, although the temperature measuring pulse light emitting timing to the heating pulse light is controlled by using a delay line, it is possible to separately use a light source for the heating pulse light and a light source for the temperature measuring pulse light, and control timing of both lights by an electrical signal(s) at the oscillation of the pulse light.

When the temperature rise ΔT (tₚₚ) by the pulse heating to amplitude δT of the reference signal is less than 1 to a certain extent, delay ø of the phase at a certain delay time tₚₚ to the phase of the reference signal is proportional to the temperature rise by pulse heating at time tₚₚ after the pulse heating, and is represented by the following formulas (1) (refer to Japanese Laid Open Patent No. 2003-139585 as to details of a minute signal measuring method):

$$tan ( ϕ ) \approx ϕ \approx \frac{Δ T ( {t}_{pp} ) sin θ}{2 δ T} \qquad ( 1 )$$

The theta (θ) is a phase to the intensity modulation of the reference signal.

As shown in a formula (2), the phase change to the reference signal is proportional to the temperature amplitude of the reference signal to the temperature rise by pulse heating.

Supposing that the thin film is insulated on the interface on the substrate side and the surface of the thin film, the maximum temperature rise ΔTmax by pulse heating is represented based on the time change of a phase to the heating pulse acquired by the measurement as follows:

$$Δ {T}_{max} = \frac{Q}{{ρ}_{f} {c}_{f} {d}_{f}} = \frac{Q}{{C}_{f}} \qquad ( 2 )$$

In the formula, energy absorbed by the thin film per unit area unit heating pulse, the density of the thin film, the specific heat capacity of the thin film, the thickness of the thin film, and the thermal effusivity of the substrate, are represented by Q, ρ_{f}, c_{f}, d_{f}, and bₛ, respectively. The thin film heat capacity per unit area is represented by the following equation:
C_{f}=ρ_{f} c_{f} d_{f}.

On the other hand, the temperature amplitude δT of a reference signal corresponds to the modulation frequency f_{mod}.

The quantity of heat q supplied per unit area unit time is represented by using the energy Q absorbed by the thin film per unit area unit heating pulse and repeating frequency fᵣₑₚ as follows:

$$q = \frac{{f}_{rep} Q}{2} \qquad ( 3 )$$

When the relationship of the heat characteristic time τ_{f} which crosses the film, and the thermal effusivity β of the substrate to the thin film is expressed as ¹⁰⁷ mod τ_{f}<<1, β<<1, the phase delay d to the temperature amplitude of the reference signal and the modulation of heating light can be represented as follows:

$$\begin{matrix}δ T = \frac{q}{{b}_{s} \sqrt{2 π {f}_{mod}}} \frac{1}{\sqrt{{ζ}^{2} + {( 1 + ζ )}^{2}}} & ( 4 ) \\ θ = \frac{3}{4} π + arctan ( - \frac{ζ + 1}{ζ} ) & ( 5 ) \\ \begin{matrix}ζ = \sqrt{π {f}_{mod} {τ}_{s}} , & {τ}_{s} = \frac{{C}_{f}^{2}}{{b}_{s}^{2}}\end{matrix} & ( 6 )\end{matrix}$$

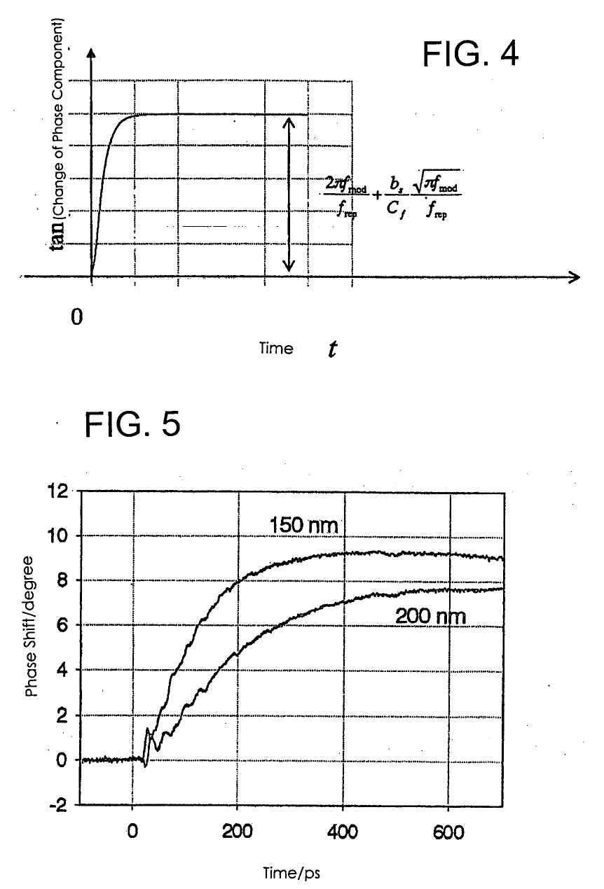

These variables expressed by these equations (2), (3), (4), (5), and (6) are substituted for the respective variables in the formula (1) and the ratio of the maximum value of the phase change to the amplitude of the reference signal is expressed by the following formula (refer to FIG. 4):

$$\begin{matrix}tan ( {ϕ}_{max} ) = \frac{1}{{f}_{rep}} \{ 2 π {f}_{mod} + \sqrt{\frac{π {f}_{mod}}{{τ}_{s}}} \} \\ = \frac{1}{{f}_{rep}} \{ 2 π {f}_{mod} + \frac{{b}_{s}}{{C}_{f}} \sqrt{π {f}_{mod}} \} \\ = \frac{2 π {f}_{mod}}{{f}_{rep}} + \frac{{b}_{s}}{{C}_{f}} \frac{\sqrt{π {f}_{mod}}}{{f}_{rep}} .\end{matrix} \qquad ( 7 )$$

By transposing the 1st term of the right side of the formula (7) to the left side, compensated phase variation X is defined as follows:

$$\begin{matrix}X = tan ( {ϕ}_{max} ) - \frac{2 π {f}_{mod}}{{f}_{rep}} & ( 8 ) \\ X = \frac{{b}_{s}}{{C}_{f}} \frac{\sqrt{π {f}_{mod}}}{{f}_{rep}} & ( 9 )\end{matrix}$$

The maximum phase change compensated from the formula (8) is in inverse proportion to the thin film specific heat capacity per unit area, as shown in the formula (9).

The most unique point of this formula is that the optical property (a reflectance, the temperature coefficient of the reflectance, and the absolute value of the energy density of the light absorbed) of a thin film is not contained in the relational expression.

On the other hand, when calculating specific heat capacity from the variation of signal amplitude, it is indispensable to know the optical property of each thin film, and therefore, the calculation procedure of thin film heat capacity is complicated, and it is difficult in practice.

As shown in the formula (9) , f_{mod} and fᵣₑₚ are quantity decided by an experimental condition, and since the compensated maximum phase change is a quantity observed, if the thermal effusivity of the substrate is known, the heat capacity per unit area of the thin film can be calculated.

### EXAMPLE

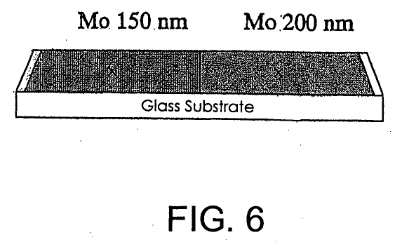

In order to verify that a delay time longer than that of the conventional measurement art can be realized, the 200 nm molybdenum thin film with a 150 nm thickness, which was formed on a glass substrate by sputtering was prepared, as shown in FIG. 6, and the phase component was measured by a picosecond thermo-reflectance method. As a result, a thermo-reflectance signal as shown in FIG. 5 was detected.

Based on the detected signal, value 1330 Jm⁻²s^{-0.5} of bulk was used as a value of the thermal effusivity of the glass substrate, and when the heat capacity per unit volume of the molybdenum thin film was calculated based on the formula, the results are shown in Table 1. A value close to 2.53 Jm⁻³K⁻¹ was acquired as the heat capacity per unit volume of the thin film of the bulk of molybdenum.

When the heat capacity per unit area of the tungsten thin film similarly formed by weld slag, the value of the heat capacity per unit volume, approximately 2.57 Jm⁻³K⁻¹, which is the value the bulk of tungsten has, was acquired. The specific heat of the thin film was calculated when regarding the density of the thin film as a known value. Further, the thermal conductivity in a thickness direction was calculated from the heat capacity per unit volume and the thermal diffusivity.

TABLE 1

| | Thick- | | Heat | Heat | | |
|---|---|---|---|---|---|---|
| | ness of | Thermal | Capacity | Capacity | | Thermal |
| | Thin | Diffus- | per Unit | per Unit | Specific | Conduc- |
| Sample | Film | ivity | Area | Volume | Heat | tivity |
| Name | nm | 10⁻⁵m²s⁻¹ | Jm⁻²K⁻¹ | 10⁶Jm⁻³K⁻¹ | Jkg⁻¹K⁻¹ | Wm⁻¹K⁻¹ |
| Mo150 | 150 | 2.8 | 0.36 | 2.4 | 230 | 66 |
| Mo200 | 200 | 3.0 | 0.52 | 2.6 | 250 | 78 |
| Mo bulk | | 5.4 | | 2.5 | 248 | 138 |

According to the present invention, it is possible to measure the thin film heat capacity per unit area of the thin film with a thickness of 1 micrometer or less without precisely deciding the optical property of the thin film sample by using a picosecond thermo-reflectance method.

The specific heat capacity of a thin film can be measured by making the thickness and the density of the thin film to known values, and the specific heat capacity, the thermal diffusivity, and the thermal conductivity required for the thermal design of the devices using a thin film, can be measured.

It is expected that data maintenance of thin film heat properties will progress drastically and device development will be accelerated by a highly reliable thermal design.

Thus the present invention possesses a number of advantages or purposes, and there is no requirement that every claim directed to that invention be limited to encompass all of them.

The disclosure of Japanese Patent Application No. 2003-128738 filed on, May 7, 2003 including specification, drawings and claims is incorporated herein by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

1. A method for measuring thermophysical property of a thin film formed on a substrate, the method comprising the following steps of:
measuring a ratio of a heat capacity per unit area of the thin film and a thermal effusivity of the substrate,
measuring a heat capacity per unit area of the thin film regarding the thermal effusivity as a known value.

2. The method for measuring thermophysical property of a thin film according to claim 1, further including,
heating a surface of the thin film by modulated light with a frequency f_{mod},
calculating a ratio of a heat capacity per unit area of the thin film and the thermal effusivity of the substrate, based on a phase component in temperature change of the surface of the thin film.

3. The method for measuring thermophysical property of a thin film according to claim 1, further including,
pulse-heating a surface of the thin film by pulse light with a repetition frequency fᵣₑₚ which is a frequency generated by carrying out intensity modulation to a frequency f_{mod},
calculating a ratio of a heat capacity per unit area of the thin film and a thermal effusivity of the substrate, based on a ratio of a temperature response of the frequency f_{mod} and a temperature rise generated before the thin film is heated by a following pulse.

4. The method for measuring thermophysical property of a thin film according to claim 3, wherein the ratio of a temperature response of the frequency f_{mod} and a temperature rise generated before the thin film is heated by a following pulse is measured from a phase change of a surface temperature, which is synthesized with the frequency f_{mod}.

5. The method for measuring thermophysical property of a thin film according to claim 1, wherein light is used as a heating source.

6. The method for measuring thermophysical property of a thin film according to claim 1, wherein the substrate is transparent, and further including, heating one side of the thin film formed on the transparent substrate and detecting a temperature response on a surface formed on the thin film by heat radiation from a sample.

7. The method for measuring thermophysical property of a thin film according to claim 1, further including heating one side of the thin film formed on a transparent substrate wherein a temperature response on a surface on which the thin film is formed is measured based on a intensity change of a reflected temperature measuring light.

8. The method for measuring thermophysical property of a thin film according to claim 7, wherein pulse light is used as the temperature measuring light for detecting the temperature response, and the temperature response is measured by controlling a time difference between the temperature measuring light and heating pulse light.

9. The method for measuring thermophysical property of a thin film according to claim 1, wherein the heat capacity per unit volume is measured by regarding a thickness of the thin film as a known value.

10. The method for measuring thermophysical property of a thin film according to claim 1, wherein a specific heat capacity is measured by regarding a density of the thin film.

11. The method for measuring thermophysical property of a thin film according to claim 1, further including, measuring heat capacity per unit area of the thin film from change of detected phase component signal, and measuring thermal conductivity in a thickness direction of the thin film.

12. An apparatus for measuring thermophysical property of a thin film formed on a substrate, comprising:
a measuring device in which a ratio of a heat capacity per unit area of the thin film and a thermal effusivity of the substrate, and
a calculator in which the heat capacity per unit area of the thin film is calculated by regarding the thermal effusivity of the substrate as a known value.

13. The apparatus for measuring thermophysical property of a thin film according to claim 12, further including a heater for heating a surface of a thin film sample at a frequency f_{mod}, and calculator in which a ratio between the heat capacity per unit area of the thin film and the thermal effusivity of the substrate from a phase component in temperature change of the frequency f_{mod} on a surface of the sample.

14. The apparatus for measuring thermophysical property of a thin film according to claim 12, further including, a pulse-heater in which a surface of the thin film by pulse light with a repetition frequency fᵣₑₚ which is a frequency generated by carrying out intensity modulation to a frequency f_{mod}, is heated by pulse light,
a calculator in which a ratio of a heat capacity per unit area of the thin film and a thermal effusivity of the substrate, based on a ratio of a temperature response of the frequency f_{mod} and a temperature rise generated before the thin film is heated by a following pulse is calculated.

15. The apparatus for measuring thermophysical property of a thin film according to claim 14, wherein the ratio of a temperature response of the frequency f_{mod} and a temperature rise generated before the thin film is heated by a following pulse is calculated from a phase change of a surface temperature, which is synthesized with the frequency f_{mod}.

16. The apparatus for measuring thermophysical property of a thin film according to claim 12, wherein light is used as a heating source.

17. The apparatus for measuring thermophysical property of a thin film according to claim 12, wherein the substrate is transparent, and further including, a heater in which one side of the thin film formed on the transparent substrate is heated and a detector in which a temperature response on a surface formed on the thin film is detected by heat radiation from a sample.

18. The apparatus for measuring thermophysical property of a thin film according to claim 12, further including a heater in which one side of the thin film formed on a transparent substrate is heated, and
a detector in which a temperature response on a surface on which the thin film is formed is measured based on a intensity change of a reflected temperature measuring light.

19. The apparatus for measuring thermophysical property of a thin film according to claim 12, wherein pulse light is used as the temperature measuring light for detecting the temperature response, and the temperature response is measured by controlling a time difference between the temperature measuring light and heating pulse light.

20. The apparatus for measuring thermophysical property of a thin film according to claim 12, wherein the heat capacity per unit volume is measured by regarding a thickness of the thin film as a known value.

21. The apparatus for measuring thermophysical property of a thin film according to claim 12, wherein a specific heat capacity is measured by regarding a density of the thin film.

22. The apparatus for measuring thermophysical property of a thin film according to claim 12, further including, a heat capacity measuring device in which heat capacity per unit area of the thin film from change of detected phase component signal is measured, and a thermal conductivity measuring device in which thermal conductivity in a thickness direction of the thin film is measured.
